(19) United States
(12) Patent Application Publication
(10) Pub. No.: US 2016/0236773 A1
(43) Pub. Date: Aug. 18, 2016

(54) DYNAMIC PITCH ADJUSTMENT DEVICES, SYSTEMS, AND METHODS

(71) Applicant: LORD CORPORATION, Cary, NC (US)

(72) Inventors: Mark R. JOLLY, Raleigh, NC (US); Lane R. MILLER, Fuquay-Varina, NC (US)

(21) Appl. No.: 15/029,806

(22) PCT Filed: Oct. 31, 2014
(86) PCT No.: PCT/US2014/063287

§ 371 Date: Apr. 15, 2016

Related U.S. Application Data
(60) Provisional application No. 61/898,030, filed on Oct. 31, 2013.

(51) Int. Cl. B64C 27/00; B64C 27/64; B64C 27/615

(52) U.S. Cl. CPC B64C 27/001; B64C 27/615; B64C 27/64; B64C 2027/003

(57) ABSTRACT

Vibration control systems, devices, and methods are provided for a rotary wing aircraft having a rotor including a plurality of blades (20) each attached to a hub (10) at its root end and capable of pitching with respect to the hub (10). The systems, devices, and methods include a blade pitch adjuster (100) that is passively adjustable in response to aerodynamic loading on the plurality of blades (20) to adjust a pitch of one of the plurality of blades (20) with respect to the hub (10) based on a frequency of the aerodynamic loading. The blade pitch adjusters (100) can be configured to exhibit relatively high stiffness at the rotor rotating frequency and tailored dynamics at frequencies higher than the rotor rotating frequency such that hub loads at one or more higher harmonics are reduced.

### PRIORITY CLAIM

The present application claims the benefit of U.S. Provisional Patent Application Ser. No. 61/898,030, filed Oct. 31, 2013, the disclosure of which is incorporated herein by reference in its entirety.

### TECHNICAL FIELD

The subject matter disclosed herein relates generally to helicopter vibration control systems and methods. More particularly, the subject matter disclosed herein relates to systems, devices, and methods for controlling vibration generated from helicopter rotor hub loads.

### BACKGROUND

Most helicopter vibration originates from aerodynamic loading of the blades which in turn imparts vibratory loads and moments on the rotor hub through the blade root. These loads propagate through the helicopter gearbox and into the cabin and are predominantly manifested as vibration at the blade pass frequency or N/Rev where N is the number of blades. For example, a four bladed helicopter for which the main rotor spins at 5 Hz will have predominant hub loads and cabin vibration occurring at 4/Rev=20 Hz.

Helicopter manufacturers typically combat N/Rev vibration using tuned proof-mass vibration absorbers located within the helicopter cabin, or proof mass pendulum absorbers located on the rotor head. For example, the Bell V-22 and the Sikorsky S-92 use pendulum absorbers on the rotor head to attenuate in-plane hub load. The Eurocopter BK-117 uses pendulum absorbers on the rotor head to attenuate out-of-plane (i.e., vertical) hub loads and moments. These solutions tend to be very heavy and only target loads in one or two axes.

In contrast to these substantially passive vibration control systems, the use of active control solutions on the rotors and the rotorhead to control vibratory hub loads has been a topic of research for many years, although such solutions have yet to be widely implemented in production. One approach involves the installation of actuators into the rotor pitchlinks, which are thus called active pitchlinks. This approach does not change the primary function of the pitchlinks to pitch the blades at 1/Rev based on swashplate angle, but the actuators can further superimpose additional blade pitch at higher harmonics (e.g., 2/Rev, 3/Rev, 4/Rev). For example, using a control system, the actuators can superimpose blade pitch at N/Rev harmonics in order to reduce certain hub loads and moments. While these systems have been proven effective at reducing hub loads and vibration in simulations and experimental environments, practical implementation is very challenging. In one example, active pitchlinks typically require considerable power, and delivering reliable power through a slipring and across articulating joints is difficult and unreliable.

A similar approach to reducing N/Rev hub loads and vibration is to employ active trailing edge flaps on each blade. Similar to active pitchlinks, when operated at higher harmonics, active flaps cause the blade to pitch at higher harmonics. With proper control, active trailing edge flaps are able to reduce N/Rev hub loads. However, these systems suffer the same drawbacks as active pitchlinks. Additionally, these systems present the additional challenge of getting electromechanical or electro-hydraulic components to operate effectively and reliably in a very high centrifugal acceleration environment.

### SUMMARY

The presently-disclosed subject matter enables reduced N/Rev hub loads and moments while addressing some of the shortcomings of the approaches mentioned above.

In one aspect, a vibration control device for a rotary wing aircraft having a rotor including a plurality of blades each attached to a hub at its root end and capable of pitching with respect to the hub is provided. The device comprises a blade pitch adjuster that is passively adjustable in response to aerodynamic loading on the plurality of blades to adjust a pitch of one of the plurality of blades with respect to the hub based on a frequency of the aerodynamic loading.

In another aspect, a vibration control device for such a rotary wing aircraft comprises a fluid-elastic pitchlink connected between the root end of the respective one of the plurality of blades and the hub. The fluid-elastic pitchlink comprising a dynamic link element that comprises a fluid inertia track through which fluid is movable in response to harmonic loads on the rotor and an elastomeric element configured to allow axial compression and extension of the fluid-elastic pitchlink. In this configuration, the fluid-elastic pitchlink is passively adjustable in response to aerodynamic loading on the plurality of blades to adjust a pitch of one of the plurality of blades with respect to the hub based on a frequency of the aerodynamic loading.

In yet another aspect, a method for controlling vibration for a rotary wing aircraft having a rotor including a plurality of blades each attached to a hub at its root end and capable of pitching with respect to the hub is provided. The method comprises, in response to aerodynamic loading on the plurality of blades, passively adjusting a blade pitch adjuster connected to one of the plurality of blades to adjust a pitch of the respective one of the plurality of blades with respect to the hub based on a frequency of the aerodynamic loading.

Numerous objects and advantages of the subject matter will become apparent as the following detailed description of the preferred embodiments is read in conjunction with the drawings, which illustrate such embodiments.

### BRIEF DESCRIPTION OF THE DRAWINGS

FIG. 1 illustrates a pitchlink on a helicopter rotor according to an embodiment of the presently disclosed subject matter.

FIG. 2A illustrates a side view of self-contained dynamic pitchlink according to an embodiment of the presently disclosed subject matter.

FIG. 2B illustrates a cross-sectional side view of the dynamic pitchlink shown in FIG. 2A.

FIG. 3 illustrates a schematic representation of dynamically tailored pitchlink according to an embodiment of the presently disclosed subject matter.

FIG. 4 illustrates a schematic representation of a plurality of individual dynamic pitchlinks installed on a helicopter rotor according to an embodiment of the presently disclosed subject matter.

FIG. 5 illustrates a schematic representation of a plurality of interconnected dynamic pitchlinks installed on a helicopter rotor according to an embodiment of the presently disclosed subject matter.

FIGS. 6A and 6B illustrates graphs of typical performance achieved by a dynamically tailored pitchlink in accordance with embodiments of the present subject matter.

FIG. 7A illustrates a front view of pair of dynamic pitchlinks with hydraulic interconnects according to an embodiment of the presently disclosed subject matter.

FIG. 7B illustrates a side view of the dynamic pitchlinks illustrated in FIG. 7A.

FIG. 7C illustrates a cross-sectional side view of the pair of dynamic pitchlinks with hydraulic interconnects illustrated in FIGS. 7A and 7B.

FIG. 8 illustrates a trailing edge flap of a helicopter blade with a dynamic hinge joint according to an embodiment of the presently disclosed subject matter.

FIG. 9 illustrates a sectional side view of a dynamically tailored passive trailing edge flap of a helicopter blade according to an embodiment of the presently disclosed subject matter.

### DETAILED DESCRIPTION

The subject matter herein includes systems, devices, and methods for controlling vibration generated from helicopter rotor hub loads. In particular, for a rotary wing aircraft having a rotor including multiple blades attached to a hub at their root end and capable of pitching, the present systems, devices, and methods provide each blade with a passive system for inducing blade pitching. This passive system is configured such that it exhibits relatively high stiffness at the rotor rotating frequency (i.e., 1P) and tailored dynamics at frequencies higher than the rotor rotating frequency (i.e., >1P) such that hub loads at one or more higher harmonics (NP) are reduced.

Referring to a helicopter pitchlink, a passive fluidic or fluid-elastic pitchlink provides relatively high stiffness at 1/Rev frequency thereby enabling the primary function of the pitchlink. The pitchlink further exhibits passive tailored dynamics at higher frequencies to enable higher harmonic pitching of the blades thereby reducing hub loads and moments. Much of the performance benefits that active pitchlinks provide are achieved without running power to the rotorhead and across articulating joints. The passive dynamically tailored pitchlink can be lighter and much more reliable since control components (e.g., sensors, controller, wiring) are not needed.

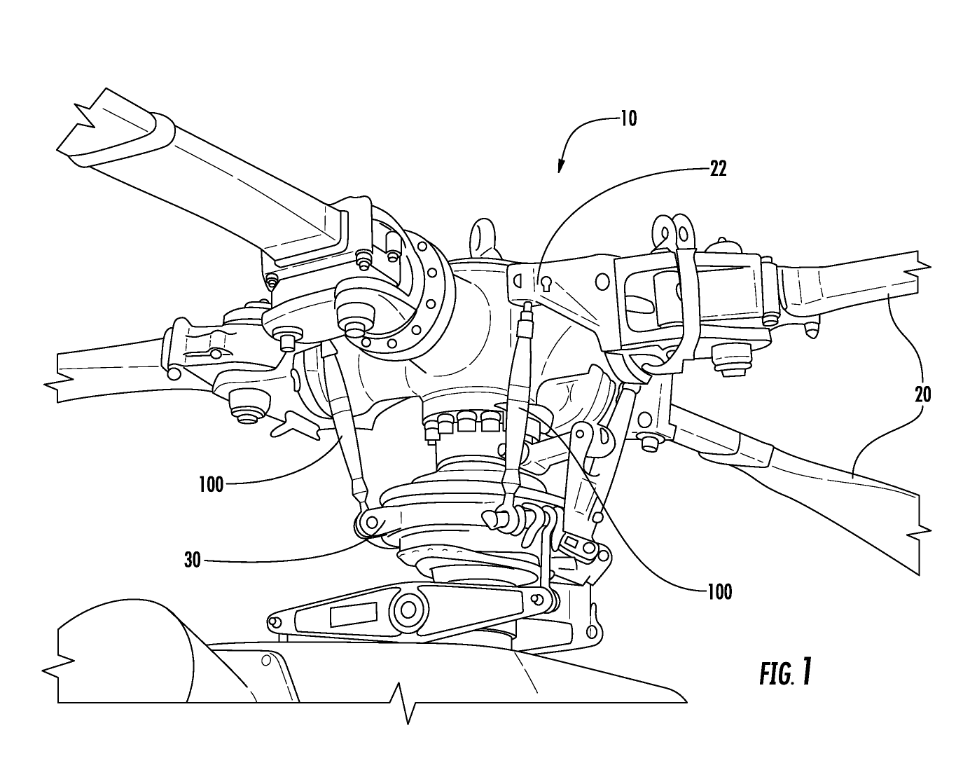

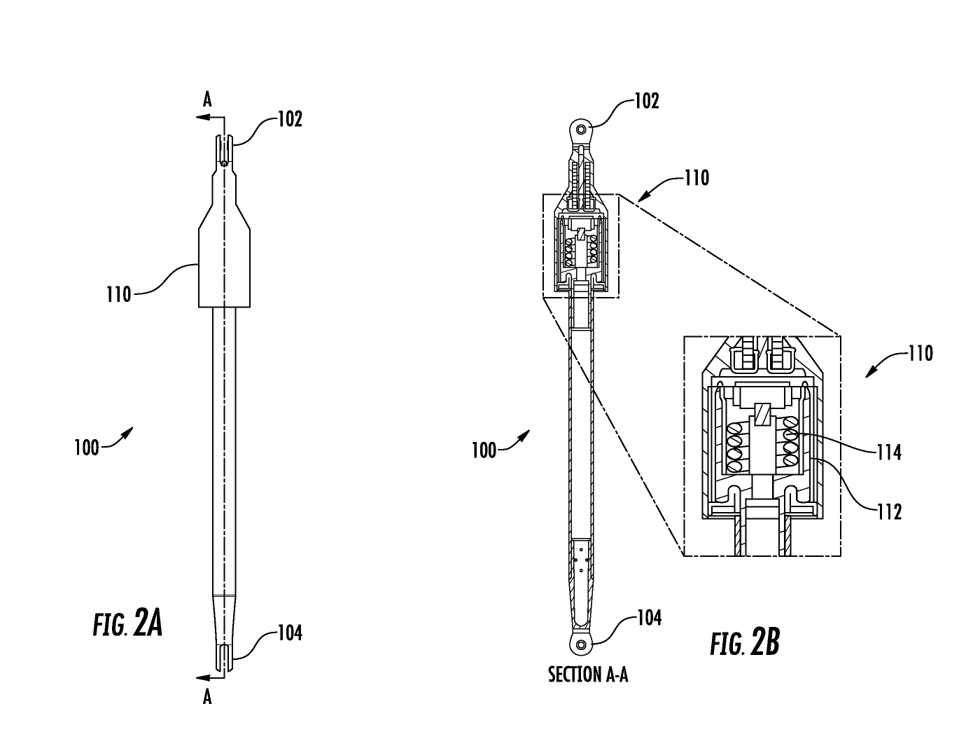

FIG. 1 illustrates a plurality of fluidic or fluid-elastic pitch adjusters, generally designated 100, where each are connected about a helicopter rotor hub 10 between one of a corresponding plurality of blades 20 (e.g., connected to a pitch horn 22 of each blade 20) and a swash plate 30. In this configuration, pitch adjusters 100 are provided as tubeform elements arranged to bear axial loads that develop due to relative motion of blades 20 with respect to rotor hub 10. In the embodiments illustrated in FIGS. 2A-2B, each of pitch adjusters 100 has an elongate shape that includes a first end 102, a second end 104 substantially opposing first end 102, and a dynamic link element 110 positioned therebetween. As illustrated, first and second ends 102, 104 connect to the blades 20 and swash plate 30 using any of a variety of connection mechanisms, such as hard bearings (e.g., metal/ceramic rod end bearings) or elastomer bearings.

To achieve the desired dynamic response to the axial loads experienced, pitch adjusters 100 are configured to provide a variable force response dependent upon the frequency vibrations at the rotor. FIG. 2B illustrates the example of a dynamic link element 110 including at least one fluid inertia track 114 through which a fluid (e.g., high density and low viscosity) is flowable within dynamic link element 110. FIG. 2B illustrates one embodiment where fluid inertia track 114 has a generally helical shape such that a large track length can be housed in a minimum volume size. Alternatively, those having skill in the art will recognize that other shapes and configurations of fluid inertia track 114 can be used. In some embodiments, fluid inertia track 114 is further connected to a hydraulic line or accumulator that is external from dynamic link element 110. In any arrangement, aerodynamic loads acting on the blades at N/Rev harmonics create harmonic loading in pitch adjusters 100. These harmonic loads tend to pump the fluid in an oscillatory manner through fluid inertia track 114, creating a fluid inertia within dynamic link element 110.

Referring to the configuration illustrated in FIG. 2B, dynamic link element 110 further comprises an elastomeric element 112 coupled between first end 102 and second end 104. In this configuration, elastomeric element 112 allows axial compression and extension of pitch adjusters 100, thereby allowing movement of a respective one of blades 20 with respect to swash plate 30 to adjust the pitch of the blade. In addition, fluid inertias developed in fluid inertia track 114 act upon internal elastomeric bulge compliances of elastomeric element 112 to create internal dynamics within pitch adjuster 100.

Through adjusting various design features, the dynamic response can be tailored within a selected frequency range (e.g., corresponding to N/Rev harmonic). This tailored dynamic response is designed to impact the pitch motion impedance at the root of each of blades 20. The tailored dynamic responses include, but are not limited to, elastomeric properties (e.g., stiffness, damping) and geometry, fluid properties (e.g., viscosity, density), and fluid inertia track geometry (e.g., cross section, effective length). In some embodiments, structural features of pitch adjuster 100 (e.g., piston area) and/or the geometry of the attached structures are further adaptable to provide the desired tailored dynamic response. Referring to FIG. 3, a schematic representation of a dynamic pitchlink using pitch adjuster 100 on a rotor hub is illustrated. In the configuration shown in FIG. 3, some of the various design features that are adjustable to modify the dynamic response include an equivalent diameter D of a piston element 116, an elastomer spring constant k_{d}, a rod end spring constant k₀ between first end 102 and piston element 116, and accumulator pressure pₐ, among others. By tailoring the dynamics of one or more parameters of this system, a blade root torsional impedance is achieved resulting in reduced hub loads.

Again, the dynamic response to changing hub loads can be modified by adjusting the various design features. In an exemplary embodiment, the tailored dynamic response includes relatively high stiffness at 1/Rev. This baseline stiffness enables translation of swashplate motion to the pitch of each of blades 20 at 1/Rev as is necessary for proper helicopter performance. The tailored dynamic response at frequencies above 1/Rev (e.g., at harmonics of 1/Rev) enables the blades to pitch in this frequency range in response to aerodynamic loads such that transmitted hub loads and moments are reduced.

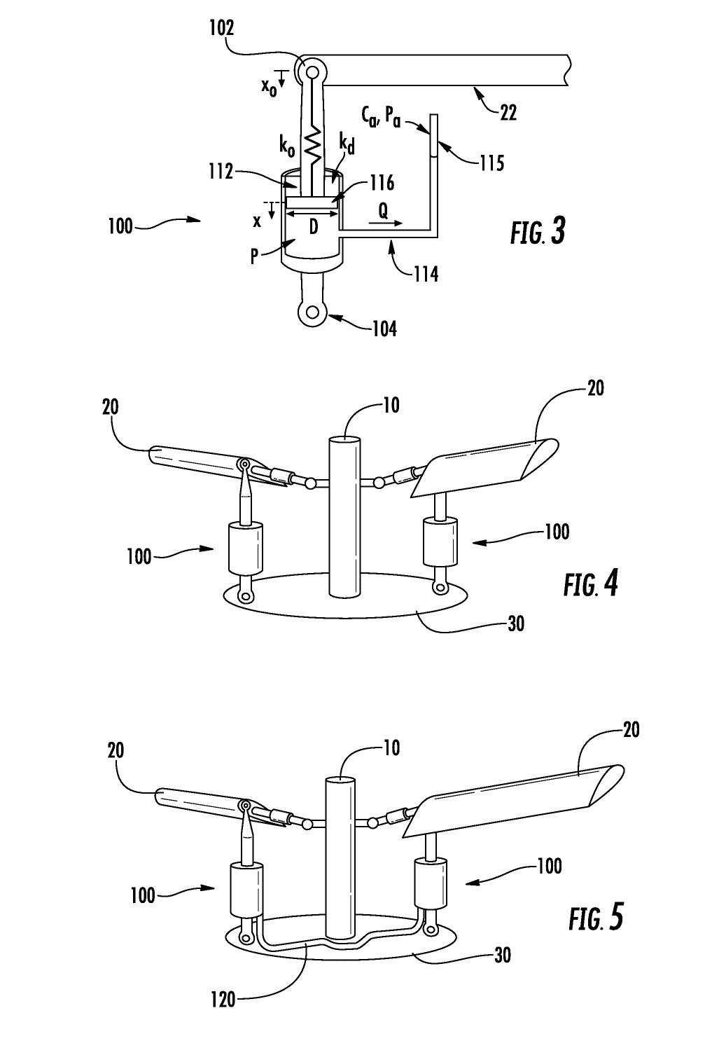

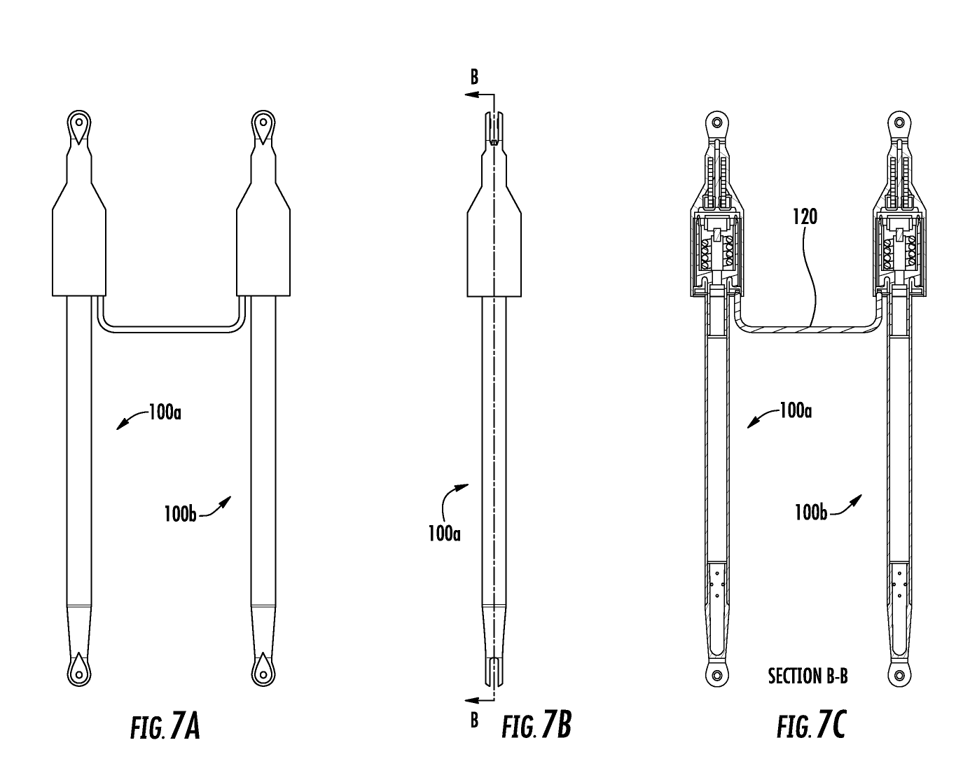

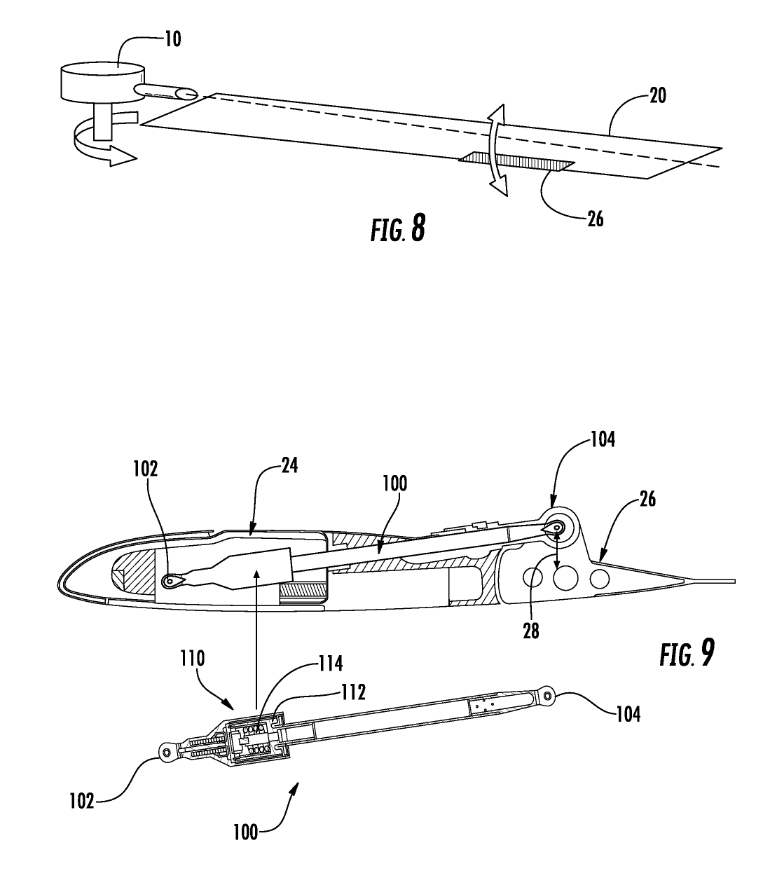

FIGS. 4 and 5 illustrate schematic representations of various configurations of pitch adjusters 100 being integrated as pitchlinks about a rotor hub 10. For illustration purposes, the non-limiting example of a two-bladed helicopter is shown. FIG. 4 shows dynamically tailored pitch adjusters 100 arranged pitchlinks on each blade. As aerodynamic loads are imparted on each of pitch adjusters 100, the torsional impedance of the corresponding blade root 22 results in blade motions that, in turn, result in reduced hub loads and moments. FIG. 5 shows pitch adjusters 100 being used as dynamic pitchlinks in a system that also include a hydraulic interconnection 120 connected therebetween. As illustrated in FIGS. 7A-7C, fluid intertie track 114 of a first pitch adjuster 100a can be connected to fluid inertia track 114 of a second pitch adjuster 100b by way of hydraulic interconnection 120 such that fluid oscillation within one fluid inertia system is communicated to the fluid inertia system of other connected elements. With this hydraulic crosstalk, the aerodynamic loads imparted on one of blades 20 impact the response of an associated one of pitch adjusters 100 as well as a force response of each of pitch adjusters 100 connected thereto by hydraulic interconnection 120. In this way, aerodynamic loads acting on one of blades 20 affect the response of the other(s). Stated otherwise, if one thinks of each of pitch adjusters 100 as a blade root driving point (i.e., torsional) impedance, then with hydraulic interconnects, the entire rotor pitchlink system can be viewed as a fully populated N×N torsional impedance matrix where N is the number of blades 20. This impedance matrix is designed to achieve reduced hub loads and moments.

In any configuration, much of the performance benefits that active pitchlinks provide are achieved without the need to run power to the rotor head and across articulating joints. Furthermore, the passive dynamically tailored pitchlink can be lighter and much more reliable since control components (sensors, controller, wiring, etc) are not needed.

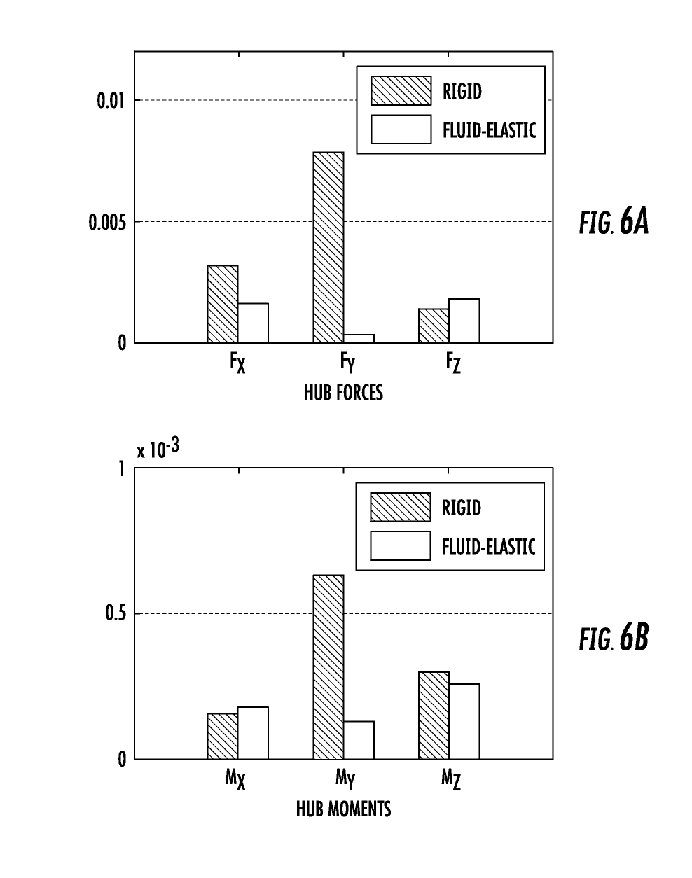

FIGS. 6A-6B provide a sample of analytical results comparing hub loads (Fx, Fy, Fz, Mx, My, and Mz) using rigid pitchlinks and optimized dynamic pitchlinks. Except for the vertical hub force Fz, hub loads are reduced with the use of dynamic pitchlinks.

In another aspect shown in FIGS. 8-9, the subject matter discussed herein is applied to a helicopter passive trailing edge flap 26 that is pivotably mounted on the one of the plurality of blades 20. In this configuration, aerodynamic loads cause passive flap 26 to articulate with respect to a blade spar 24 of blade 20. As passive flap 26 articulates up and down, it imposes a twisting moment on blade 20 that causes blade 20 to pitch and also impacts the loading between the root end of blade 20 and hub 10. In this aspect, pitch adjuster 100 is implemented as a fluidic or fluid-elastic hinge joint applied to blade trailing edge flap 26 to provide relatively high stiffness at 1/Rev frequency such that blade trailing edge flap 26 does not significantly interfere with the primary function of blades 20. In addition, the hinge joint is further designed to exhibit passive tailored dynamics at higher frequencies to induce higher harmonic pitching or twisting of the blades such that hub loads and moments are reduced. In this aspect, many of the performance benefits active trailing edge flaps provide are achieved, but by a purely passive means.

The embodiment illustrated in FIG. 9, fluidic or fluid-elastic pitch adjuster 100 is connected within the hingeline of passive flap 26 such that the tailorable dynamics of pitch adjuster 100 discussed above enable a tailored dynamic response of articulation of passive flap 26. The particular configuration of pitch adjuster 100 can be substantially similar to the configuration used in the dynamic pitchlink configuration discussed above. As illustrated in FIG. 9, this mechanism can be a linear device acting on a moment arm 28, wherein pitch adjuster 100 is connected between blade spar 24 of one of the plurality of blades 20 and flap 26. Alternatively, the mechanism can be configured as a rotary device (not shown). As with the picthlink implementation discussed above, the tailored dynamic response in a passive flap configuration can likewise include relatively high stiffness at 1/Rev, but the tailored dynamic response at frequencies above 1/Rev (e.g., at harmonics of 1/Rev) enable articulation of passive flap 26, and thus, blade 20 pitches in this frequency range in response to aerodynamic loads such that transmitted hub loads and moments are reduced.

In an alternative configuration, the subject matter discussed herein is applied to a helicopter pitchlink as discussed above in combination with active trailing edge flaps. In this combination, the benefits of conventional active trailing edge flaps can be achieved, but a significantly reduced authority can be assigned to the flaps. In this regard, a significantly reduced authority flap entails lower surface area and/or lower flap angle.

In yet further alternative configuration, the subject matter disclosed herein can further be applied to attenuate the transmission of N/Rev vibration energy through the gearbox support structure. This solution can be effective in helicopters having certain types of gearbox support structure (e.g., support struts) and/or in helicopters capable of tolerating a small amount of relative motion between the gearbox and the helicopter structure and/or engines.

Other embodiments of the current subject matter will be apparent to those skilled in the art from a consideration of this specification or practice of the subject matter disclosed herein. Thus, the foregoing specification is considered merely exemplary of the current subject matter with the true scope thereof being defined by the following claims.

What is claimed is:

1. A vibration control device for a rotary wing aircraft having a rotor including a plurality of blades each attached to a hub at its root end and capable of pitching with respect to the hub, the device comprising:
a blade pitch adjuster that is passively adjustable in response to aerodynamic loading on the plurality of blades to adjust a pitch of one of the plurality of blades with respect to the hub based on a frequency of the aerodynamic loading.

2. The vibration control device of claim 1, wherein the blade pitch adjuster comprises a dynamic link element comprising a fluid inertia track through which fluid is movable in response to harmonic loads on the rotor.

3. The vibration control device of claim 2, wherein the dynamic link element further comprises an elastomeric element configured to allow axial compression and extension of the blade pitch adjuster.

4. The vibration control device of claim 2, wherein the blade pitch adjuster comprises a pitchlink connected between the root end of the respective one of the plurality of blades and the hub.

5. The vibration control device of claim 4, wherein the dynamic link element is connected between the root end of the respective one of the plurality of blades and the hub.

6. The vibration control device of claim 4, comprising at least one hydraulic interconnect connected between the fluid inertia tracks of the blade pitch adjusters associated with at least two of the plurality of blades;
wherein each of the blade pitch adjusters connected by the at least one hydraulic interconnect is responsive to aerodynamic loading on one or more of the at least two of the plurality of blades.

7. The vibration control device of claim 2, wherein the blade pitch adjuster comprises a passive trailing edge flap;
wherein the dynamic link element is connected between a blade spar of one of the plurality of blades and a flap that is pivotably mounted on the one of the plurality of blades.

8. A vibration control device for a rotary wing aircraft having a rotor including a plurality of blades each attached to a hub at its root end and capable of pitching with respect to the hub, the device comprising:
a fluid-elastic pitchlink connected between the root end of the respective one of the plurality of blades and the hub, the fluid-elastic pitchlink comprising a dynamic link element that comprises:
a fluid inertia track through which fluid is movable in response to harmonic loads on the rotor; and
an elastomeric element configured to allow axial compression and extension of the fluid-elastic pitchlink;
wherein the fluid-elastic pitchlink is passively adjustable in response to aerodynamic loading on the plurality of blades to adjust a pitch of one of the plurality of blades with respect to the hub based on a frequency of the aerodynamic loading.

9. A method for controlling vibration for a rotary wing aircraft having a rotor including a plurality of blades each attached to a hub at its root end and capable of pitching with respect to the hub, the method comprising:
in response to aerodynamic loading on the plurality of blades, passively adjusting a blade pitch adjuster connected to one of the plurality of blades to adjust a pitch of the respective one of the plurality of blades with respect to the hub based on a frequency of the aerodynamic loading.

10. The method of claim 9, wherein passively adjusting the blade pitch adjuster comprises passively adjusting the stiffness of a dynamic link element of the blade pitch adjuster.

11. The method of claim 10, wherein passively adjusting the stiffness of a dynamic link element comprises moving a fluid through a fluid inertia track contained within the dynamic link element in response to harmonic loads on the rotor.

12. The method of claim 11, wherein passively adjusting the stiffness of the dynamic link element comprises moving the fluid through at least one hydraulic interconnect connected between the fluid inertia tracks of the blade pitch adjusters associated with at least two of the plurality of blades;
wherein each of the blade pitch adjusters connected by the at least one hydraulic interconnect responds to aerodynamic loading on one or more of the at least two of the plurality of blades.

13. The method of claim 12, wherein fluid inertias developed in the fluid inertia track act upon internal elastomeric bulge compliances of an elastomeric element contained within the dynamic link element.

14. The method of claim 9, wherein the blade pitch adjuster comprises a pitchlink connected between the root end of the respective one of the plurality of blades and the hub.

15. The method of claim 9, wherein the blade pitch adjuster comprises a passive trailing edge flap.
